(19) United States
(12) Patent Application Publication
(10) Pub. No.: US 2026/0028993 A1
(43) Pub. Date: Jan. 29, 2026

(54) FLEX-MOUNTED POWER TOOL WITH BACKPACK SUPPORT

(71) Applicant: Milwaukee Electric Tool Corporation, Brookfield, WI (US)

(72) Inventors: Joseph S. Wilinski, JR., Wauwatosa, WI (US); Kyle J. Reeder, Waukesha, WI (US); Keith Grider, Brookfield, WI (US); Michael S. Van Dyke, Wauwatosa, WI (US); Brad Gill, Brookfield, WI (US); Harry T. Ward, Mequon, WI (US); Adam F. Czerwonka, Mukwonago, WI (US); Shannon C. Bartlett, Cedarburg, WI (US); Colin Roberts, Brookfield, WI (US); Jonathan L. Paul, Brookfield, WI (US)

(21) Appl. No.: 19/280,878

(22) Filed: Jul. 25, 2025

Related U.S. Application Data
(60) Provisional application No. 63/675,500, filed on Jul. 25, 2024.
(60) Provisional application No. 63/708,086, filed on Oct. 16, 2024.
(60) Provisional application No. 63/739,993, filed on Dec. 30, 2024.

(51) Int. Cl. F04D 29/40; A01G 20/47; A47L 5/14; A47L 9/00; A47L 9/28; E01H 1/08; F04D 25/08

(52) U.S. Cl. CPC F04D 29/403; A01G 20/47; A47L 5/14; A47L 9/0009; A47L 9/2857; E01H 1/0809; F04D 25/08; E01H 2001/0881

(57) ABSTRACT

A backpack supported power tool is provided. The power tool includes a frame including a back plate having an upper end and a lower end and defining a back plate plane; and a tool body coupled to the frame by a coupling apparatus. The coupling apparatus includes a coupler configured to enable movement of the tool body in a lateral side to side direction relative to the back plate plane. The tool body includes a user interface configured to be gripped by a user to support and direct movement of the tool body.

### CROSS-REFERENCE TO RELATED APPLICATIONS

The present application claims priority to U.S. Provisional Patent Application Ser. No. 63/675,500, filed on Jul. 25, 2024, U.S. Provisional Patent Application Ser. No. 63/708,086, filed on Oct. 16, 2024, and U.S. Provisional Patent Application Ser. No. 63/739,993, filed on Dec. 30, 2024, the disclosure of each of which are incorporated by reference herein in their entirety.

### FIELD

The present disclosure relates generally to backpack supported power tools.

### BACKGROUND

Portable hand-held blowers are popular for, for example, home maintenance and commercial landscaping tasks. Typical hand-held blowers are either powered by gasoline engines or electric motors. A fan is connected to the motor or engine and rotates within a blower housing. The fan generates an air flow that is directed towards an outlet of the housing. An extension tube is generally connected to the outlet of the housing to direct the air flow from the housing therethrough, and the air flow is then exhausted from the tube or through a nozzle connected to the tube.

Electric-powered blowers may be powered by portable batteries. However, there may be trade-offs between the weight of each battery and the efficiency and performance of the blower—for instance, improved efficiency and performance as a result of higher voltage batteries may increase the overall weight of the blower. The increased weight and size of the battery and/or the blower may also reduce the flexibility for operating. Some existing outdoor power tools may utilize a backpack support to mount the power supply of a portable blower. However, the connection between the backpack support and the handheld blower may further limit the flexibility and ease of operation of the blower, including limiting factors such as weight of the handheld portion of the blower, dimensions of the handheld portion of the blower, and flexibility of the connection mechanism between the backpack support and the handheld blower.

Accordingly, improved apparatus for portable, e.g., backpack supported, blowers are desired in the art. In particular, a blower which provides improved flexibility and user adjustment between the backpack support and the handheld blower would be advantageous.

### BRIEF DESCRIPTION

Aspects and advantages of the present disclosure will be set forth in part in the following description, or may be obvious from the description, or may be learned through practice of the technology.

In accordance with one embodiment, a backpack supported power tool is provided. The power tool includes a frame including a back plate having an upper end and a lower end and defining a back plate plane; and a tool body coupled to the frame by a coupling apparatus. The coupling apparatus includes a coupler configured to enable movement of the tool body in a lateral side to side direction relative to the back plate plane. The tool body includes a user interface configured to be gripped by a user to support and direct movement of the tool body.

These and other features, aspects and advantages of the present disclosure will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present application, including the best mode of making and using the present systems and methods, directed to one of ordinary skill in the art, is set forth in the specification, which makes reference to the appended figures, in which:

FIG. 1 is a perspective view of a backpack supported power tool in accordance with embodiments of the present disclosure;

FIG. 2 is an exploded view of a coupler of a backpack supported power tool in accordance with embodiments of the present disclosure;

FIG. 3 is a schematic top view of a backpack supported power tool illustrating range of motion of a coupler in accordance with embodiments of the present disclosure;

FIG. 4 is a perspective view of a first end of the coupler in accordance with embodiments of the present disclosure;

FIG. 5 is a side view of a coupler in accordance with embodiments of the present disclosure;

FIG. 6 is a side view of a coupler in accordance with embodiments of the present disclosure illustrating range of motion of the coupler in a vertical direction;

FIG. 7 is a perspective view of a backpack supported power tool in a storage position in accordance with embodiments of the present disclosure;

FIG. 8 is a perspective view of a backpack supported power tool including electrical and/or data cables in accordance with embodiments of the present disclosure;

FIG. 9 is a partial perspective view of a backpack supported power tool in a storage position in accordance with embodiments of the present disclosure

FIG. 10 is a schematic representation of a backpack supported power tool having a rack and pinion adjustment mechanism between the backpack and the tool;

FIG. 11 illustrates a perspective view of various flex beams of a coupler in accordance with embodiments of the present disclosure;

FIG. 12 illustrates a perspective view of a compound spring as a flex beam in accordance with embodiments of the present disclosure;

FIG. 13 illustrates perspective view of a backpack supported power tool in accordance with embodiments of the present disclosure;

FIG. 14 illustrates a partial cross-sectional view of the coupler and power tool in accordance with embodiments of the present disclosure;

FIG. 15 illustrates a partial cut-away view of a power tool in accordance with embodiments of the present disclosure;

FIG. 16A illustrates a top view of a backpack supported power tool illustrating side-to-side range of motion of a coupler in accordance with embodiments of the present disclosure;

FIG. 16B illustrates a schematic illustration of range of motion of linkages of a coupler in accordance with embodiments of the present disclosure;

FIG. 16C illustrates a top view of a backpack supported power tool illustrating fore-aft range of motion of a coupler in accordance with embodiments of the present disclosure;

FIG. 16D illustrates a schematic illustration of range of motion of linkages of a coupler in accordance with embodiments of the present disclosure;

FIG. 17A illustrates a top view of a backpack supported power tool illustrating range of motion of a coupler in accordance with embodiments of the present disclosure;

FIG. 17B illustrates a rear perspective view of a backpack supported power tool in accordance with embodiments of the present disclosure;

FIG. 17C illustrates a rear perspective view of a backpack supported power tool in accordance with embodiments of the present disclosure;

FIG. 18A a rear perspective view of a backpack supported power tool in accordance with embodiments of the present disclosure;

FIG. 18B illustrates a side perspective view of a coupler of a backpack supported power tool in accordance with embodiments of the present disclosure; and

FIG. 18C illustrates a top view of a coupler of a backpack supported power tool in accordance with embodiments of the present disclosure.

### DETAILED DESCRIPTION

Reference now will be made in detail to embodiments of the present disclosure, one or more examples of which are illustrated in the drawings. The word “exemplary” is used herein to mean “serving as an example, instance, or illustration.” Any implementation described herein as “exemplary” is not necessarily to be construed as preferred or advantageous over other implementations. Moreover, each example is provided by way of explanation, rather than limitation of, the technology. In fact, it will be apparent to those skilled in the art that modifications and variations can be made in the present technology without departing from the scope or spirit of the claimed technology. For instance, features illustrated or described as part of one embodiment can be used with another embodiment to yield a still further embodiment. Thus, it is intended that the present disclosure covers such modifications and variations as come within the scope of the appended claims and their equivalents. The detailed description uses numerical and letter designations to refer to features in the drawings. Like or similar designations in the drawings and description have been used to refer to like or similar parts of the disclosure.

As used herein, the terms “first”, “second”, and “third” may be used interchangeably to distinguish one component from another and are not intended to signify location or importance of the individual components. The singular forms “a,” “an,” and “the” include plural references unless the context clearly dictates otherwise. The terms “coupled,” “fixed,” “attached to,” and the like refer to both direct coupling, fixing, or attaching, as well as indirect coupling, fixing, or attaching through one or more intermediate components or features, unless otherwise specified herein. As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive- or and not to an exclusive- or. For example, a condition A or B is satisfied by any one of the following: A is true (or present) and B is false (or not present), A is false (or not present) and B is true (or present), and both A and B are true (or present).

Terms of approximation, such as “about,” “generally,” “approximately,” or “substantially,” include values within ten percent greater or less than the stated value. When used in the context of an angle or direction, such terms include within ten degrees greater or less than the stated angle or direction. For example, “generally vertical” includes directions within ten degrees of vertical in any direction, e.g., clockwise or counter-clockwise.

Benefits, other advantages, and solutions to problems are described below with regard to specific embodiments. However, the benefits, advantages, solutions to problems, and any feature(s) that may cause any benefit, advantage, or solution to occur or become more pronounced are not to be construed as a critical, required, or essential feature of any or all the claims.

In general, electric backpack blower solutions must meet user needs of blow-force (power) and runtime at a reasonable weight limit (32 lbs). Implementing a backpack supported tool having a lightweight flexible spring to support the weight of the side-mounted tool reduces the weight required to be supported by a user while enabling a substantial range of motion in a side to side direction, and the spring assists with return of the tool to a neutral position. Providing a pitch mechanism to enabling vertical rotation of the tool enables a substantial range of motion in an up and down direction. Additionally, utilizing a blower fan in front of the user improves system efficiency.

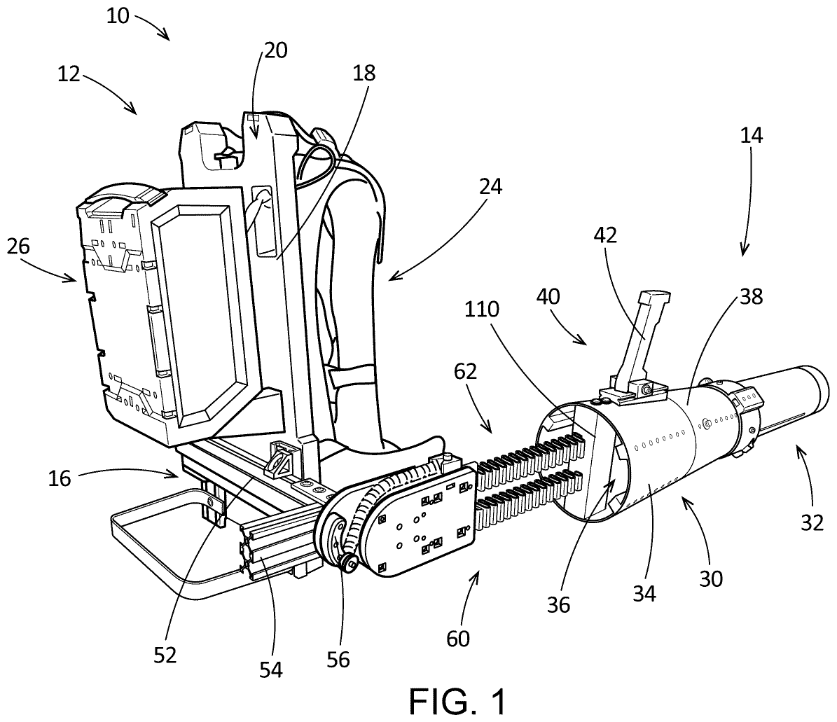

Referring now to the drawings, FIG. 1 illustrates a backpack supported power tool 10 including a backpack assembly 12 and a tool body 14. As shown in FIG. 1, the tool body 14 may be a blower, such as an axial blower. However, the present inventors contemplate that the tool body may be any type of backpack supported power tool, such as a backpack sprayer or a cutting device, e.g., a chain saw or a hedge trimmer.

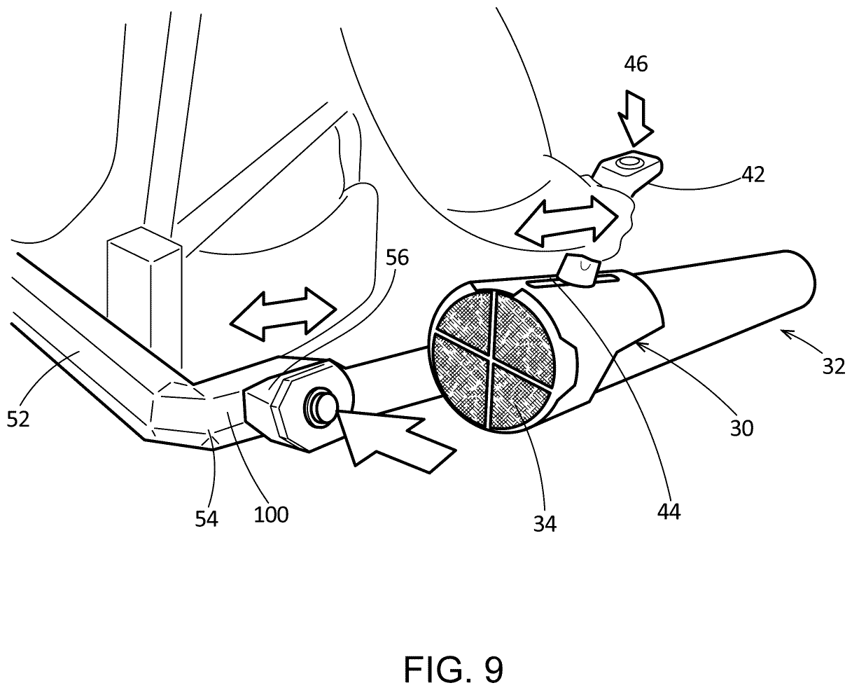

The backpack assembly 12 includes a frame 16 including a back plate 18. The back plate 18 extends from an upper end 20 to a lower end 22 and defines a back plate plane between the upper end and lower end (best seen in FIG. 8). The backpack assembly 12 further includes shoulder straps 24 coupled to the back plate 18 that are configured to be worn against the user's back to support the weight of the tool 10. The backpack supported power tool 10 may be electrically powered by one or more power tool battery packs (not shown). The backpack assembly 12 may include a battery mounting assembly 26 configured to receive the one or more batteries and provide electrical power to the tool body 14. The batteries may be removably coupled to the backpack assembly 12.

FIG. 1 illustrates the tool body 14 as an axial blower. The axial blower includes a blower housing 30 and a blower outlet tube 32 coupled to a downstream end of the blower housing 30. The blower housing 30 defines a blower inlet bell 34 having a blower inlet 36, and a fan-motor chamber 38 disposed downstream of the blower inlet bell 34. A motor and an axial fan (not shown) are disposed in the fan-motor chamber 38. The motor is electrically powered by the one or more batteries mounted in the backpack assembly 12 and drives the fan to draw air into the blower housing 30 through the inlet 36, and exhaust air from the blower housing 30 through an outlet (not shown) coupled with the blower outlet tube 32. The outlet tube 32 is coupled to the blower housing 30 proximate the outlet in order to direct the exhausted air.

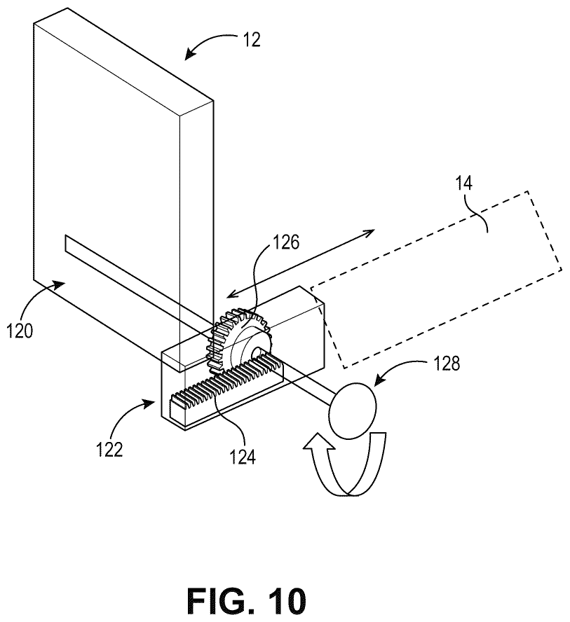

A user interface 40, such as a handle or joystick 42, is coupled to the blower housing 30. When the user interface 40 is in the form of a joystick, the joystick 42 extends in a vertical direction from an upper surface of the blower housing 30. Stated differently, a blower axis may be defined along the airflow direction of the axial blower from the blower inlet 36 through the outlet tube 32, and the joystick 42 may extend in a direction generally perpendicular to the blower axis. The user interface 40 is electrically coupled to the batteries and the motor. The user interface 40 may include one or more buttons 46 (FIG. 9) configured to be actuated by a user to provide electrical current to the motor, which drives the fan and produces a stream of air through the blower housing 30 and outlet tube 32. The handle 42 is also used for positioning and manipulating the outlet tube 32, and thereby directing the outlet and stream of air in a desired direction.

In some aspects of the present invention, the handle or joystick 42 is coupled to the blower inlet bell 34 of the blower housing 30. In some aspects of the present invention, the handle or joystick 42 may be coupled to the fan-motor chamber 38 of the blower housing 30. For instance, the handle or joystick 42 may be arranged in a position that is upstream or aft of the motor and fan assembly, downstream or in front of the motor and fan assembly, or in line with (e.g., above) the motor and fan assembly. In some aspects, the tool body 14 has a center of gravity (CG) that may coincide with the motor and fan assembly. The handle or joystick 42 may be arranged in a position that is upstream or aft of the CG of the tool body 14, downstream or in front of the CG of the tool body 14, or in line with (e.g., above) the CG of the tool body 14.

In some aspects of the present invention, e.g., as illustrated in FIG. 9, the handle or joystick 42 may be adjustably coupled with the blower housing 30. For instance, a slot 44 may be provided in the blower housing 30, and the handle or joystick 42 may translate along the slot 44. The slot 44 may be generally parallel to the blower axis and may extend through at least a portion of the blower inlet bell 34 and/or through at least a portion of the fan-motor chamber 38 of the blower housing 30. In this arrangement, the handle or joystick 42 may be slidably adjusted from a position that is upstream or aft of the motor and fan assembly to a position that is downstream or in front of the motor and fan assembly, including a position that is in line with (e.g., above) the motor and fan assembly. In some aspects, the slot 44 may include discrete positions arranged at regular intervals at which the joystick 42 may be positioned. In other aspects, the joystick 42 may be secured in place at any position along a length of the slot 44 without requiring to be located at discrete positions.

The present inventors have found that the tool body 14 having a motor disposed in the tool body 14 has more weight than existing back-supported tools that have a motor disposed in the backpack assembly, i.e., more weight and more inertia that the user must counteract when holding the joystick 42 and guiding the tool body 14. As a result, the position of the joystick 42 relative to the fan and motor assembly of the tool body 14, and therefore, the CG of the tool body 14, directly impacts the user's ability to hold and use the tool 10 comfortably over a period of time while supporting the weight of the tool body 14. Providing a position for the joystick 42 that is aft of the motor and fan assembly in the tool body 14 may result in an arrangement whereby less force is required to counteract the inertia of the tool body 14. Moreover, the ability to adjust the position of the joystick 42 enables a user to find their personal most comfortable and ergonomic arrangement of the tool 10.

Returning now to FIG. 1, the tool body 14 is side-mounted to the backpack assembly 12. In other words, when the backpack assembly 12 is worn by a user and supported on the user's back, the tool body 14 extends along one side of the user's body. While FIG. 1 illustrates the tool body 14 disposed on the right side of the backpack assembly 12, it is to be understood that the tool body 14 may alternatively be disposed on the left side of the backpack assembly 12. Further, the tool 10 may include a plurality of tool bodies 14, e.g., a tool body 14 on each of the right side and the left side, both coupled with the backpack assembly 12.

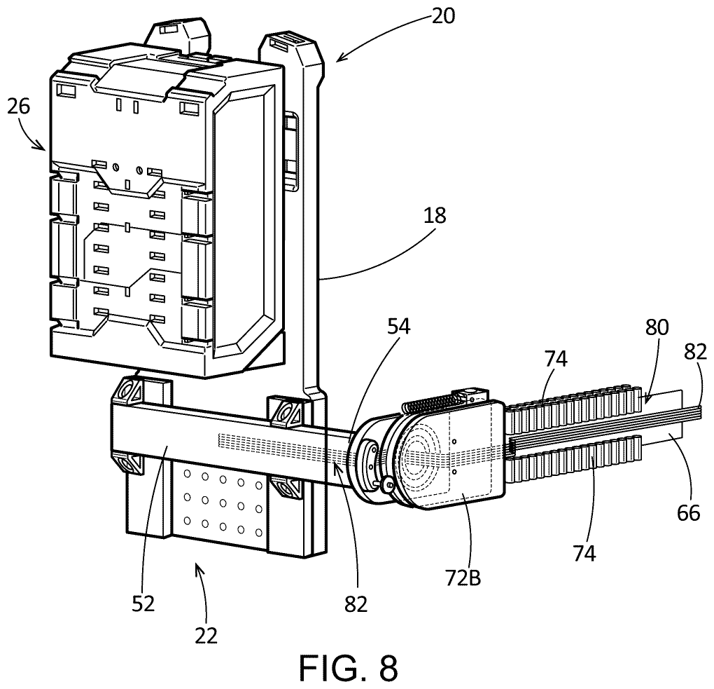

A coupling apparatus 50 (FIG. 7) is provided to couple the tool body 14 to the backpack assembly 12. As shown in FIG. 1, the coupling apparatus 50 includes a first support bar 52 coupled to the back plate 18 and extending outward to a lateral side of the back plate 18. The first support bar 52 may extend along or parallel to the back plate plane. A second support bar 54 may be provided at a lateral end of the first support bar 52 and may be oriented or extend in a direction generally perpendicular to the first support bar 52. A coupler 60 is coupled to the first support bar 52 or the second support bar 54. As illustrated, the coupler 60 is coupled to the second support bar 54 that extends generally perpendicular to the back plate plane. For instance, a coupling block 56 may be directly coupled with the first support bar 52 or the second support bar 54 and with the coupler 60.

The coupler 60 is configured to enable movement of the tool body 14 relative to the backpack assembly 12. In this manner, the coupler 60 may include a bending beam 62 or other flexible member configured to enable movement of the tool body 14 in a side to side lateral direction relative to the user, i.e., relative to an axis defined by the second support bar 54, and a pitch mechanism 64 configured to enable movement of the tool body 14 in an up and down or vertical direction relative to the user.

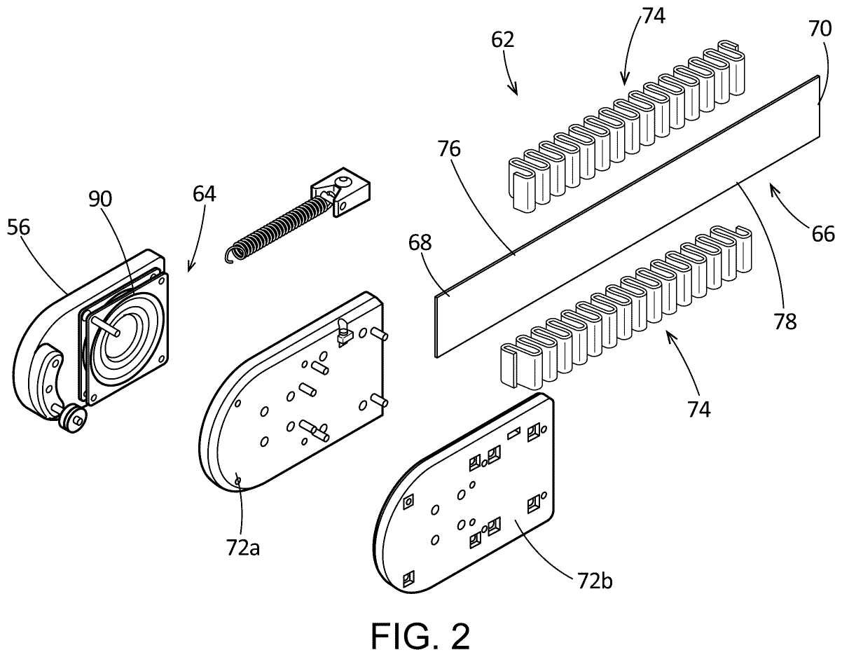

FIG. 2 illustrates an exploded view of the coupler 60. The bending beam 62 includes an elongated body 66. The elongated body 66 is configured to extend between a bending beam first end 68 and a bending beam second end 70. At the bending beam first end 68, a pair of clamp blocks 72a, 72b may be provided. For instance, the bending beam first end 68 may be sandwiched between the clamp blocks 72a and 72b to hold the bending beam first end 68 in place. At the opposite end, i.e., the bending beam second end 70, the elongated body 66 may be coupled to the tool body 14. The bending beam 62 is configured to be arranged parallel to the direction of airflow, i.e., along the blower axis, and in-line with the blower axis, thereby counteracting blow force generated by a blower tool and assisting with reduction of user fatigue. Further details of the structure of the interface between the bending beam 62 and the tool body 14 are provided below.

The elongated body 66 of the bending beam 62 may be formed from an elongated bar or rod, and may be formed from a variety of materials and/or material composites. The elongated body 66 may be linear or nonlinear. Additionally, one or more supports may be coupled with the elongated body 66 of the bending beam 62. For instance, as illustrated in FIG. 2, the elongated body 66 may be formed from a single piece or bar of tempered spring steel. Along the length of the elongated body 66 from the first end 68 to the second end 70, the bar of tempered spring steel may have a constant width and height. For example, in one specific implementation of the disclosure, the elongated body 66 may include a piece of elongated tempered spring steel having a width of about 0.035 inches and a height of about 2 inches.

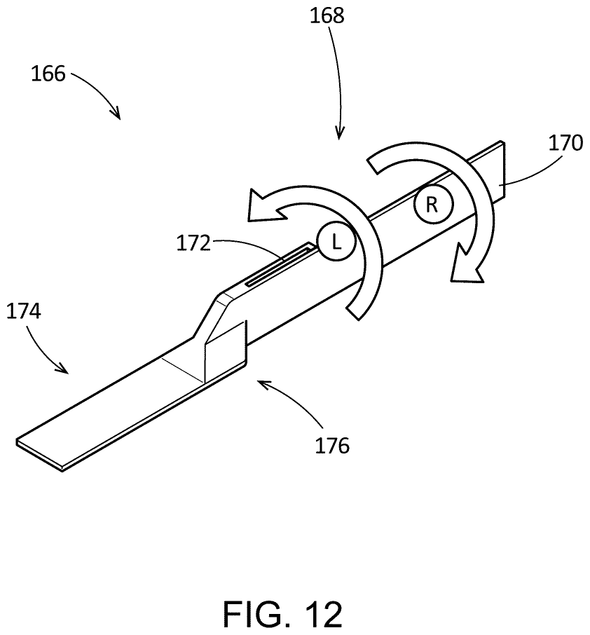

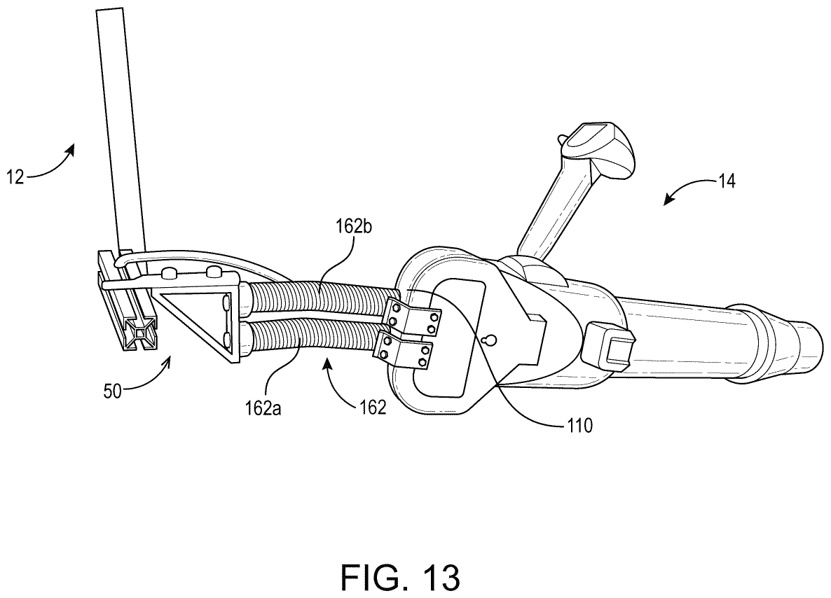

However, it is to be understood that the elongated body 66 may take a variety of forms, including shape, dimensions, and materials, based on the desired characteristics of the tool 10. For example, the elongated body 66 may further be formed from a tapered bar, a rod having a constant or a tapered diameter, a crinkle or wavy shaped bar, a corrugated bar, a folded triangle (i.e., a single piece of bar material formed into an elongated triangle shape), a truss, a ribbon, and/or a belt, as shown in e.g. FIG. 11. The elongated body 66 may be formed from any suitable material, including but not limited to tempered spring steel, plastic injection-molded material, polyester, fiberglass, carbon fiber, formed sheet metal, or a combination thereof. Additionally or alternatively, the elongated body 66 may include an overmolded material, such as a rubber and/or silicone overmold, to modify the flexing characteristics and/or to protect a user from sharp edges and to protect the elongated body 66 from damage.

For instance, as shown in FIG. 2, the elongated body 66 may include one or more torsion stiffeners 74. The torsion stiffener(s) 74 may provide stiffening support to the elongated body 66 and improve torsional stability of the bending beam 62. For instance, the torsion stiffener(s) may enable fine tuning of the spring rate of the elongated body 66. In some embodiments, the torsion stiffener(s) 74 may be formed from a plastic material and have a corrugated shape, as shown in FIG. 2. For example, in some aspects of the disclosure, the elongated body 66 may include two corrugated plastic torsion stiffeners 74, one disposed along a top edge 76 of the elongated body 66 and one disposed along a bottom edge 78 of the elongated body 66. As best seen in FIGS. 1 and 9, a space 80 may be formed between upper and lower torsion stiffeners 74 at which the elongated body 66 may be exposed.

In some aspects of the invention, the elongated body 66 may be formed as one or more of a variety of spring profiles. For instance, as best seen in FIG. 11, the elongated body 66 may include one or more progressive or stacked springs 170, 172, which may increase the force required to deflect the spring over distance in a particular direction. A progressive spring may be formed from a single integrated piece of material, as shown in FIG. 11. For example, FIG. 11 illustrates a stacked spring having a spring 170 formed as a normal spring configured to flex in a clockwise direction, and a stacked spring 172 adjacent to the spring 170 which increases the difficulty of deflecting the springs 170, 172 in the counterclockwise direction.

In some aspects, an integrated spring 166 may further include a spring configured to enable flexing of the bending beam 62 in an up and down direction to adjust the pitch of the tool body 14. In this manner, an integrated spring 166 may include a first spring 168 configured to flex in a lateral side to side direction and a second spring 174 at an opposite end from the first spring 168 and configured to flex in an up and down pitch direction, e.g., in addition to or as a substitute for the pitch bearing 90 described above. For instance, when a tempered steel spring bar is used to form the integrated spring 166, the first spring 168 may extend in a direction generally perpendicular to the second spring 174 and a spring junction 176 may be formed between the first spring 168 and the second spring 174.

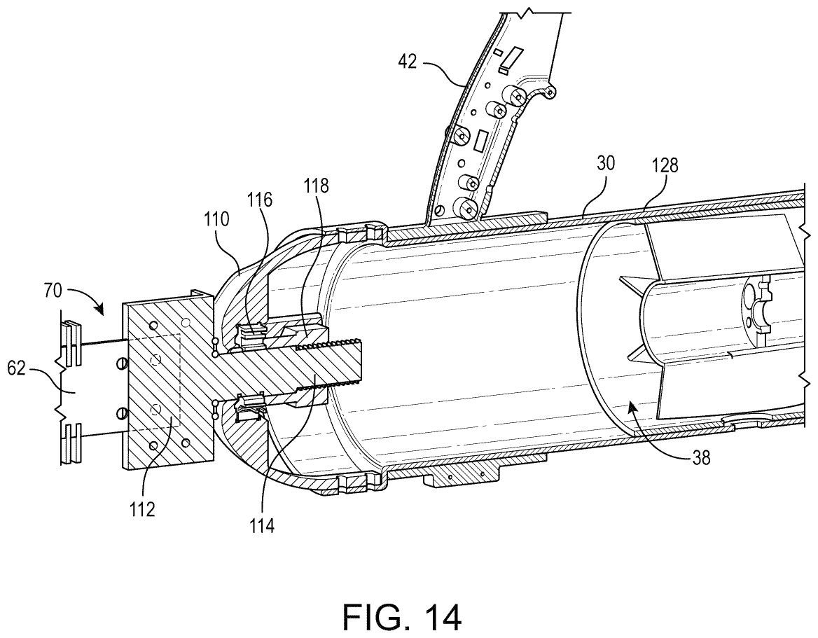

In some aspects, one or more coil springs 162 may be provided between the coupling block 56 and the blower tool 14. For instance, a first coil spring 162a and a second coil spring 162b may be substituted in place of the bending beam 62, as shown in FIG. 13, and/or provided in addition to the bending beam 62. When more than one coil spring is provided, the coil springs 162a, 162b may be vertically stacked or disposed in any other suitable arrangement to enable lateral side to side movement of the tool 14.

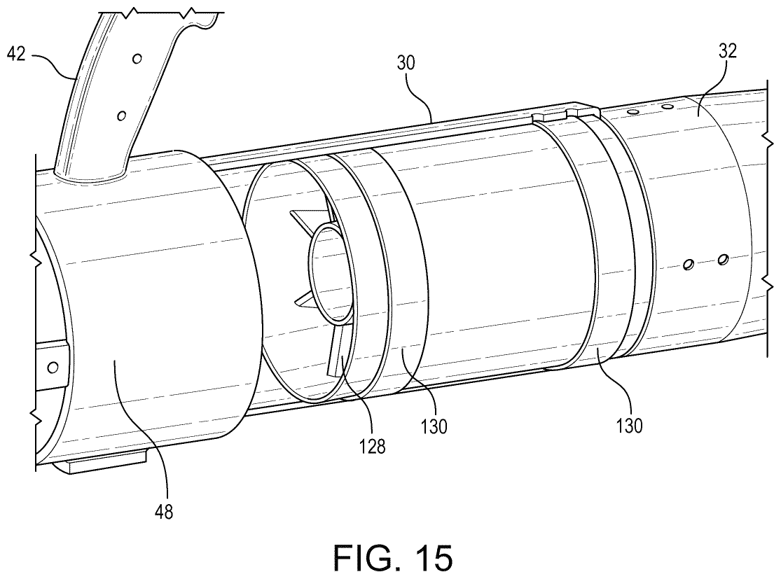

As best seen in FIG. 1 and FIG. 14, the bending beam 62 is coupled to the tool body 14 at the bending beam second end 70. For instance, the blower housing 30 may include a bending beam receiver 110 configured to receive the second end 70. In some aspects, the second end 70 of the bending beam 62 may be inserted into the receiver 110 or otherwise secured to the receiver 110. For instance, as best seen in FIG. 14, the second end 70 of the bending beam 62 may be received within a receiver housing 112. The receiver housing 112 may include a post or shaft 114 extending therefrom in a direction away from the bending beam 62. The shaft 114 may be inserted within the receiver 110. A stopper 118 may be provided at an end of the shaft 114 to hold the shaft 114 in place relative to the receiver 110 and the tool 14.

The receiver 110 may be disposed within the blower inlet 36 of the blower housing 30, and/or may be otherwise coupled to or within the blower inlet bell 34. The receiver 110 may be configured such that a long axis of the bending beam 62 extends parallel to the blower axis, i.e., is disposed centrally within the blower inlet 36. However, in some embodiments the bending beam 62 may be received laterally to the right or left of the blower axis, e.g., to alter the airpath characteristics at the blower inlet 36. The receiver 110 may be configured such that the bending beam 62 extends vertically in a direction generally perpendicular to the back plate plane in order to enable the left to right sweeping movement of the bending beam 62 described above. In some aspects, the receiver 110 may be incorporated with a screen or grate disposed at the blower inlet 36, e.g., configured to guide airflow and/or prevent debris from entering the blower inlet 36.

In some aspects, as shown in FIG. 14, the receiver 110 may further include a roller bearing 116 configured to enable relative rotation between the shaft 114 and the tool 14. For instance, rotation of the user's wrist when operating the tool 14 may enable rotation of the tool 14, specifically of the bearing 116, about the shaft 114. The shaft 114 may coincide with a longitudinal axis of the tool 14. The joystick 42 may be fixedly coupled with the housing 30, e.g., by a fixing ring 48 surrounding the housing 30, so that movement of the joystick 42 causes movement of the tool 14.

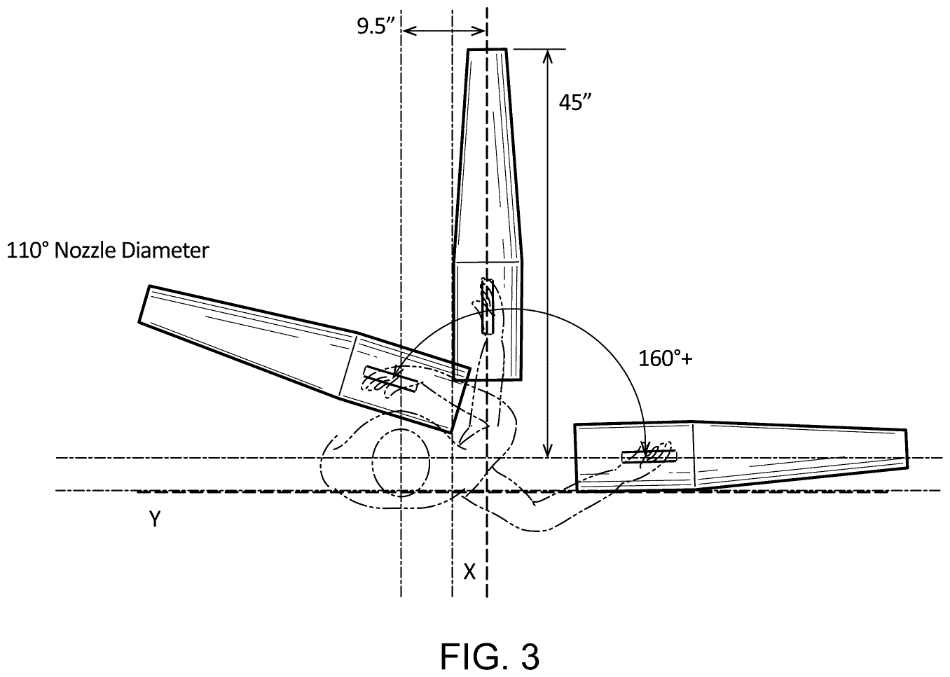

FIG. 3 illustrates a schematic representing the lateral range of motion of the bending beam 62 relative to the backpack assembly 12. At rest, the bending beam 62 and the tool body 14 extend along the blower axis, illustrated in FIG. 3 as the X-axis. The bending beam 62 may enable movement of the tool body 14 up to about 90 degrees to the right of the X-axis. Additionally, the bending beam 62 may enable movement of the tool body 14 up to about 70 degrees to the left of the X-axis. In other words, the coupler 60 including the bending beam 62 may enable a range of motion of about 160 degrees.

Moreover, the coupler 60 including the bending beam 62 may require relatively reduced actuation force to sweep the tool body 14 to the right and to the left, as compared to competitor products. For example, the tool 10 as illustrated in FIGS. 1 and 2 requires an average force of about 3.0 lbs. to sweep the tool body 14 90 degrees to the right of the X-axis, and an average force of about 2.2 lbs. to sweep the tool body 14 to a position 65 degrees to the left of the X-axis. The average (mean) value of the right and left actuation force is about 2.6 lbs. Comparative data of the average (mean) value of the right (90 degrees) and left (65 degrees) actuation force of competitor products is provided in Table 1 below. As shown, the tool 10 of the instant disclosure has an about 15% reduction in average actuation force as compared to the next closest product, Product A, and about a 50% reduction in average actuation force as compared to the product that has the highest actuation force, Product E.

TABLE 1

| Product | Mean of Left (−65°) and Right (+90°) Actuation Force |
|---|---|
| Instant Disclosure | 2.6 lbs. |
| Product A | 3.0 lbs. |
| Product B | 3.6 lbs. |
| Product C | 3.7 lbs. |
| Product D | 3.9 lbs. |
| Product E | 5.0 lbs. |

Additionally, when a spring is used to form the elongated body 66 of the bending beam 62, the spring may assist with return of the tool body 14 to a neutral or home position. Moreover, the spring may absorb and/or react to the axial thrust force generated by the blower outlet. In this manner, users may utilize the spring-back properties of the bending beam 62 in sweeping and looping techniques for guiding debris using the airflow exhausted through the blower outlet.

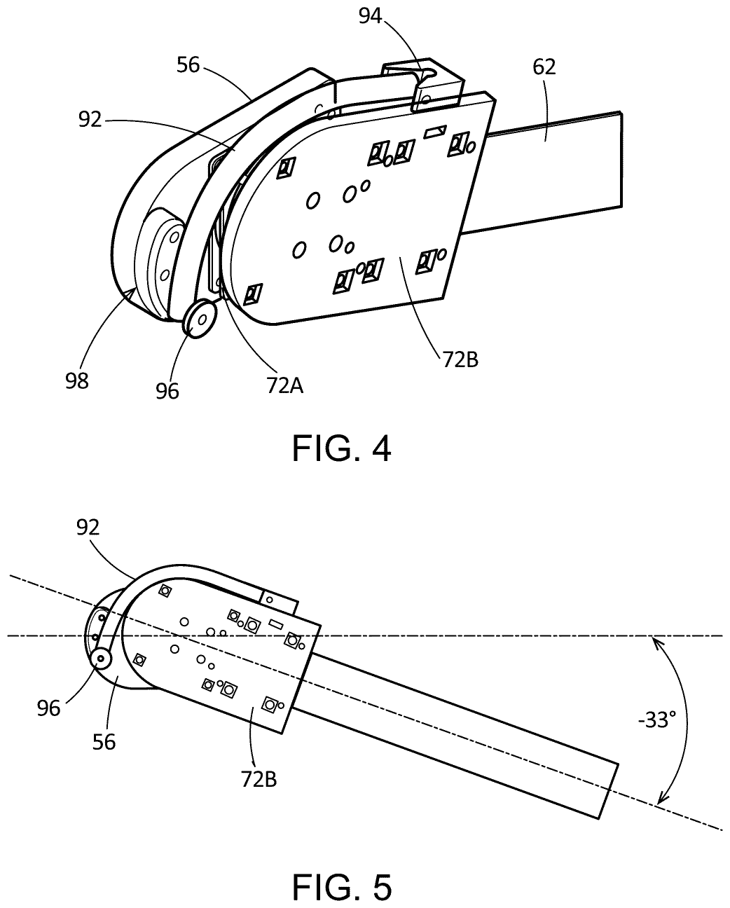

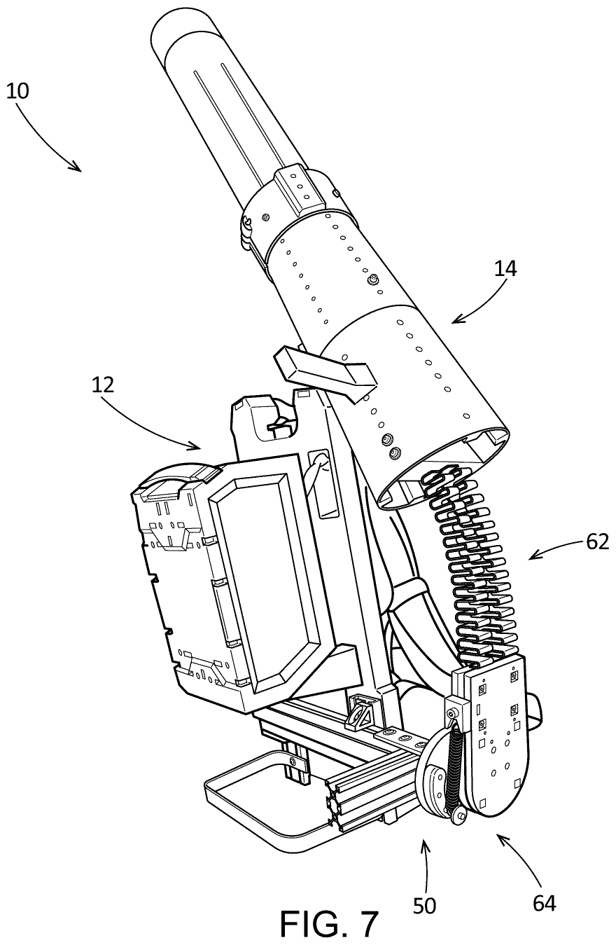

Turning now to FIGS. 2 and 4-6, the pitch mechanism 64 will be described in more detail. As shown in FIG. 2, the pitch mechanism 64 may include a pitch bearing 90. The pitch bearing 90 may be coupled to the coupler block 56 on a first side, and to the first clamp block 72a on the opposite side. The pitch bearing 90 is configured to enable rotation of the clamp block 72a relative to the coupler block 56 via rotation of the pitch bearing 90. In this manner, a pitch of the entire coupler 60 may be adjusted by rotating the pitch bearing 90. For instance, when a user grips the handle or joystick 42 and raises in an upward direction, the coupler 60 and the tool body 14 may be raised to an upward pitch by rotation of the pitch bearing 90. The pitch mechanism 64 may enable a user to rotate the tool body 14 about 90 degrees in either direction relative to a horizontal axis. Stated differently, the pitch mechanism 64 may have a range of motion of about 180 degrees, as shown in FIG. 6. In this regard, the tool 10 may have a storage position (i.e., when the tool 10 is being stored and is not in use), shown in FIG. 7, where the pitch mechanism 64 is rotated 90 degrees upward from the horizontal axis and the tool body 14 extends generally in a direction parallel to the back plate plane.

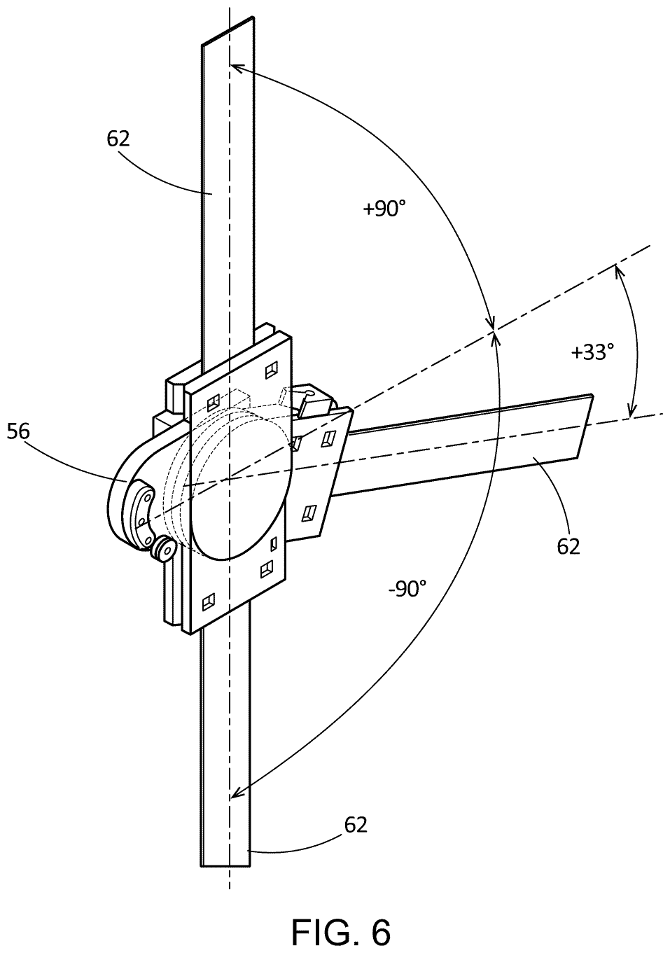

The pitch mechanism 64 may further include a pitch support extension spring 92. The pitch support extension spring 92 may assist in bearing the weight of the tool body 14. For instance, the pitch support extension spring 92 may be a coil spring. The pitch support extension spring 92 may be coupled to a first spring holder 94 coupled to the clamp blocks 72a, 72b and a second spring holder 96 coupled to the coupler block 56. In some aspects of the invention, both the clamp blocks 72a, 72b have a generally straight upper surface and curved rear surfaces such that the spring 92 may extend along the upper surfaces and around at least a portion of the curved rear surfaces to the second spring holder 96. The second spring holder 96 may be positioned below a central longitudinal axis of the coupler 60 and the bending beam 62, as best seen in FIG. 5. The coupler block 56 may further include a spring guide 98 configured to be disposed opposite the curved rear surface of the clamp blocks 72a, 72b to guide the positioning of the spring 92 and retain the spring 92 in place between the clamp blocks 72a, 72b and a surface of the spring guide 98. In this arrangement, the spring 92 is sprung to assist in bearing the weight of the tool body 14. Without the pitch support extension spring 92, the tool body 14 and coupler 60 would rest at a pitch of about −90 degrees relative to a horizontal axis, i.e., toward the floor or ground surface, due to rotation of the pitch mechanism 64. When the spring 92 has a spring rate of about 8.9 lbs./in, the pitch support extension spring 92 may enable the tool body 14 to rest at a position of about −33 degrees relative to a horizontal axis, as shown in FIG. 5.

The pitch mechanism 64 may further include, additionally to or as an alternative to the pitch bearing 90, one or more mechanisms such as a slotted pivot mechanism, a torsion spring, and/or rolling contact joints. For instance, a preloaded torsion spring may enable adjustment of the pitch in an up and down direction similar to a mechanism commonly used for garage door closures.

Turning now to FIG. 8, one or more power and/or data cables 82 may be provided to couple the power source and any electronics mounted in the backpack assembly 12 to the user interface 40 and the motor of the tool body 14. In some aspects, the cable(s) 82 may be integrated into the coupling apparatus 50, e.g., by providing a cable chase (not shown). The cable(s) 82 may extend along the first support bar 52 and/or second support bar 54, along and/or through the coupler block 56 and the clamp blocks 72a, 72b, and along the elongated body 66 of the bending beam 62 to the tool body 14. For instance, the cable(s) 82 may extend along the elongated body 66 in the space 80 between the torsion stiffeners 74. The cable(s) 82 may be provided as low profile cable(s) such as flex ribbons to form an ultra-low profile along the bending beam 62 and through the blower housing 30.

In additional aspects of the present disclosure, the coupling apparatus 50 may further enable adjustability of the location of the coupler block 56 relative to the first support bar 52 and/or second support bar 54. For instance, the coupler block 56 may be translatable in a forward/rear direction relative to the first support bar 52. In this manner, the entire coupler 60 and tool body 14 may be moved forward or rearward to enable a user to adjust the position of the tool body 14 for comfort and/or ergonomic positioning.

For instance, as illustrated in FIG. 9, a slot 100 may be provided along a portion of the second support bar 54 to enable forward and rearward translation of the coupler block 56.

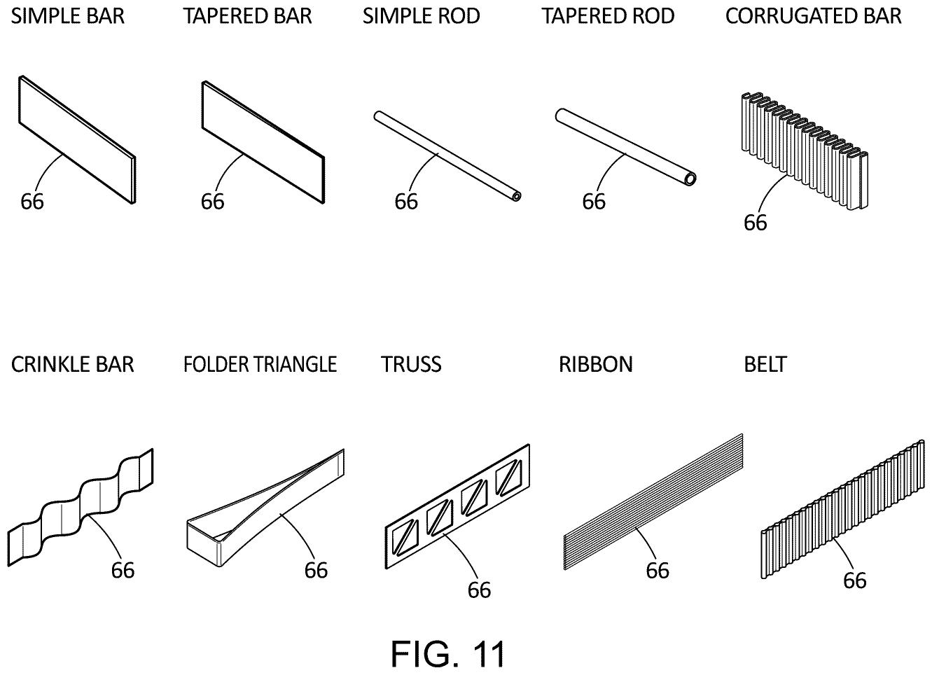

FIG. 10 illustrates a rack-and-pinion mechanism for adjusting the location of the coupler block 56 relative to the backpack assembly 12. For instance, a pinion mounting shaft 120 may be coupled to the backpack assembly 12. A rack 122 and a pinion 124 may be disposed within a housing, such as the mounting block 56. A knob 126 may be coupled to an outside of the housing, e.g., mounting block 56, to enable a user to rotate the pinion and thereby adjust the positioning of the tool 14 relative to the backpack assembly 12. In this manner, the entire coupler 60 and tool body 14 may be moved forward or rearward to enable a user to adjust the position of the tool body 14 for comfort and/or ergonomic positioning.

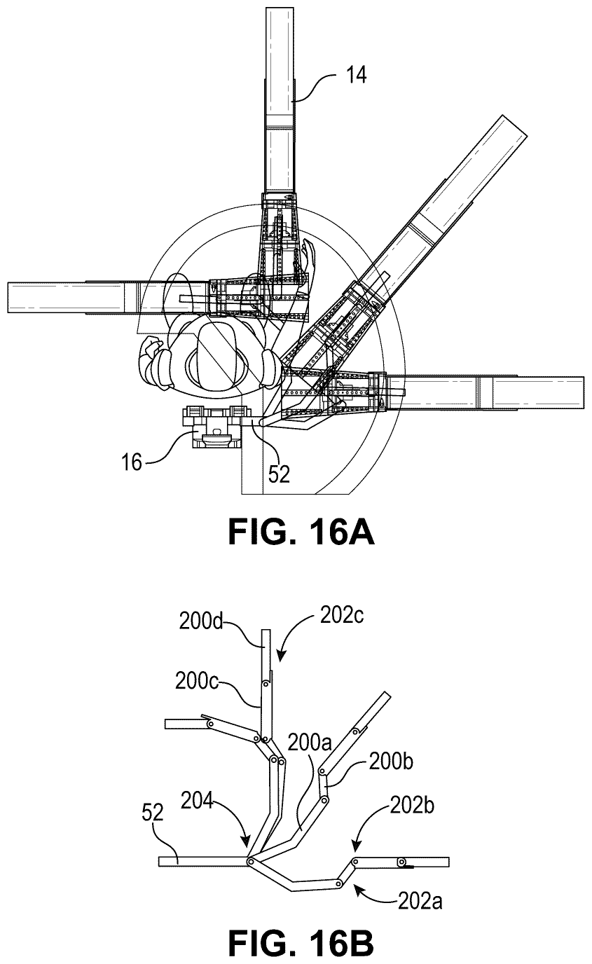

Further, as shown in FIG. 15, the blower tool 14 of the present invention may include one or more vibration damping elements. In particular, the vibration damping elements may be provided proximate to the motor and/or fan of the tool 14. FIG. 15 illustrates a motor/fan chamber 38 disposed within the housing 30 of the blower tool 14. The motor and fan may be disposed within a stator 128 within the housing 30. One or more isolation rings 130 may be provided on or around the stator 128 between the stator 128 and the housing 30. For instance, two isolation rings 130 may be provided, or any other suitable number or arrangement of isolation rings 130. In some aspects, the isolation ring(s) 130 may extend around an entire circumference of the stator 128 and/or one or more circumferential portions around the stator 128. However, one or more isolation elements may be provided in alternative geometrical arrangements, e.g., strips along the stator, etc. The isolation ring(s) 130 and/or other isolation elements may be formed from rubber or other suitable vibration damping material. By providing the isolation ring(s) 130 and/or other isolation elements, vibration and noise from the operation of the motor and the fan of the blower may be dampened, e.g., by isolating the vibration and noise from the operation of the motor and the fan from the outer housing 30 of the blower tool 14.

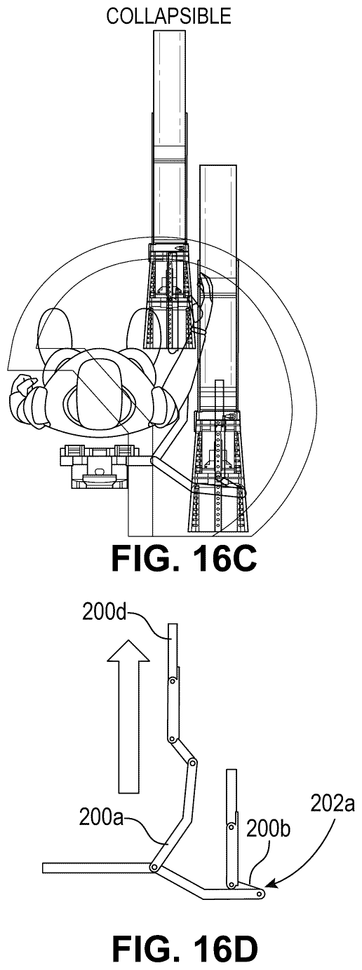

Turning now to FIGS. 16A-D, 17A-C, and 18A-B, the present invention considers several alternatives for the coupling apparatus 50 between the frame 16 and the tool body 14. In particular, the coupling apparatus 50 may include various configurations to couple between the first support bar 52 and the tool body 14 to enable movement of the blower through a user arm's range of motion. For example, a plurality of links 200 may be provided between the first support bar 52 and the tool body 14, and some or all of the plurality of links 200 may be movable relative to each adjacent one of the links 200 in at least one degree of freedom. The plurality of links 200 may be sprung, or limited, to each other to ensure predictable, intuitive motion of the tool body 14 through the range of motion of the coupling apparatus 50.

For instance, FIGS. 16A-D illustrate a coupling apparatus 50 including a first support bar 52 coupled to the frame 16, and a plurality of links 200 coupled between the first support bar 52 and the tool body 14. In particular, the coupling apparatus 50 of FIGS. 16A-D includes a plurality of links 200 configured to enable collapsing and extending of the coupling apparatus 50, thereby enabling movement of the tool body 14 toward the user's body or away from the user's body (as best seen in FIGS. 16C-D). The plurality of links 200 may include links 200a, 200b, 200c, 200d and joints 202a, 202b, 202c between them, respectively. A primary joint 204 may be disposed between the first support bar 52 and the first link 200a. The links 200 may be pivotable about each respective joint. In particular, each one of the joints 202a, 202b, 202c, and 204 may have a distinct angular range of motion. For example, the primary joint 204 may have a range of motion in a range from about 20 degrees to about 90 degrees, such as from about 40 degrees to about 70 degrees, about which range the first link 200a may move relative to the first support bar 52. The joint 202a may enable a range of motion of about 80 degrees to about 180 degrees, such as from about 100 degrees to 160 degrees, between the first link 200a and the second link 200b, specifically to move the second link 200b closer to the first link 200a when collapsing the coupling apparatus 50. The joint 202b may enable a range of motion of about 10 degrees to about 120 degrees, such as from about 30 degrees to 90 degrees, between the second link 200b and the third link 200c. The joint 202c may include a relatively shallow range of motion compared to other joints, e.g., from about 0 degrees to about 45 degrees, such as from about 5 degrees to about 40 degrees, between the third link 200c and the fourth link 200d.

Further, the plurality of links 200 may be coupled with the tool body 14 from below the tool body 14. For instance, the distal-most link from the frame 14, e.g., the fourth link 200d as shown in FIGS. 16A-D, may include a connection 210 to the tool body 14. In some aspects, the connection 210 may include a curved or concave connection body 212, e.g., a yoke, configured to receive the tool body 14 therein. One or more fasteners (not shown) may couple the connection body 212 to the tool body 14. The one or more fasteners may further enable upward and downward movement of the tool body 14 as desired by a user, e.g., along a horizontal axis defined by the one or more fasteners.

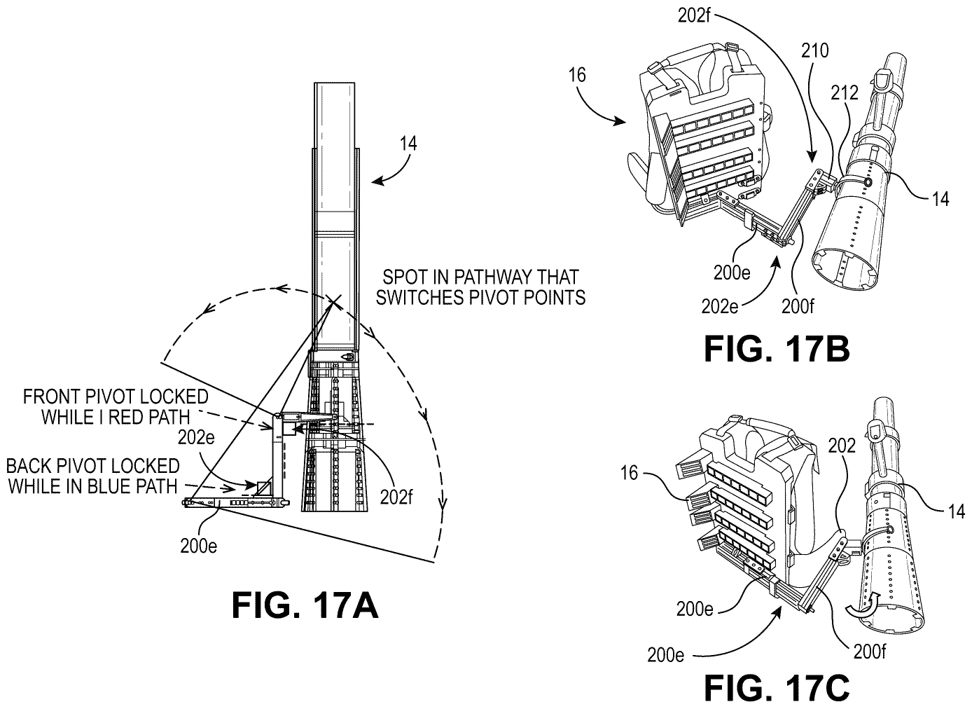

FIGS. 17A-C illustrate an aspect of the coupling apparatus 50 having a plurality of links 200 coupled to the first support bar 52, e.g., at a central portion of the frame 16 instead of to a side of the frame 16. For instance, links 200e, 200f, 200g may be provided with joints 202e, 202f therebetween. The joints 202e and 202f may be locked at a specific locking angle during use, e.g., to enable switching between the pivot points formed at the joints 202e, 202f. The pivot points may work in succession, rather than simultaneously. For instance, each joint 202e, 202f may be locked in a generally right angle when not being pivoted. The switching pivots create an elliptical pathway instead of a circular motion to better accommodate a user's reach and elbow extension.

For instance, during operation, the coupling apparatus 50 may enable pivoting about the first joint 202e when a user moves through their shoulder's range of motion, during which time the second joint 202f may remain locked. When a user intends to direct the tool body 14 across the user's body beyond the shoulder range of motion, the first joint 202e may become locked and the second joint 202f may move through its range of motion as the user moves through a range of motion with their elbow and/or wrist to steer the nozzle of the tool body 14. One or more latches (not shown) may be provided to enable the locking of the first joint 202e and second joint 202f.

As shown in FIGS. 17A-C, the connection 210 may include a concave connection body 212 or yoke similarly to that described above. In FIGS. 17A-C, the yoke may be coupled to a lateral side of the tool body 14, e.g., to increase the upward and downward range of motion of the tool body 14 as compared to providing the links 200 below the tool body 14.

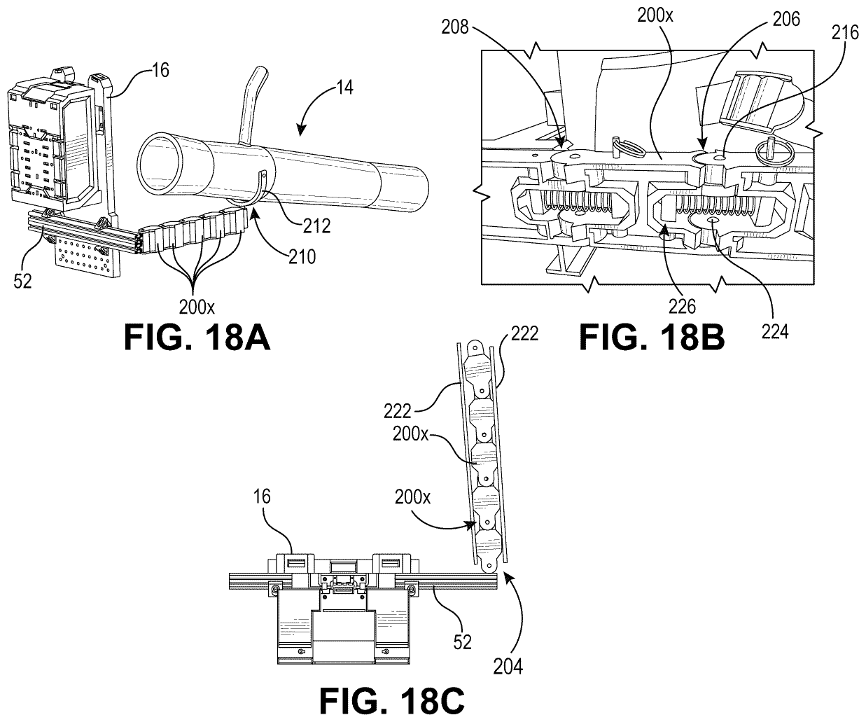

FIGS. 18A-B illustrate a similar arrangement to that shown in FIGS. 16A-D, e.g., having a plurality of links 200 coupled between the first support bar 52 and the connection 210 with the tool body 14. As best seen in FIG. 18B, each of the plurality of links 200 may optionally comprise links 200x that each have generally the same size and shape. For instance, each of the links 200x may include a receiving end 206 and a coupling end 208 at opposite longitudinal ends of the link 200x. In some aspects, the receiving end 206 may be concave or convex and may be complementarily sized and shaped to the coupling end 208 of an adjacent link 200x. Joints 200x may be provided between each adjacent one of the links 200x. The joints 200x may include a fastener 216 forming a pivot point about which the adjacent links 200x may pivot or rotate. For instance, each of the receiving end 206 and coupling end 208 may include one or more fastener receiving openings (not shown) vertically aligned to receive a fastener 216 therein. A fastener 216 may further be provided to couple between the first support bar 52 and a first one of the links 200x. However, it is to be understood that the links 200x may each have different sizes while still including complementary receiving ends 206 and coupling ends 208.

In some aspects, as best seen in FIGS. 18B-C, one or more springs may be provided with the coupling apparatus 50 to restore the links 200 to a neutral position when not being steered by a user. For instance, an elastomeric spring 222 may be provided along one or both lateral sides of the links 200x to urge the links 200x to a center or non-pivoted position. The elastomeric spring(s) 222 may extend along only a portion of the links 200x or along substantially a full length from the first support bar 52 to the connection 210.

Further, as illustrated in FIG. 18B, one or more springs 224 may be provided between adjacent links 200x. For instance, one or more compression springs 224 may be provided between a pair of adjacent links 200x. In some aspects, each of the links 200x may include a receiving channel 226 configured to receive a compression spring 224 therein. In this arrangement, the links 200x may pivot about each joint 202e, and the compression springs 224 between the adjacent links 200x may return the links 200x to a center or neutral position.

Similarly to that as described above, the coupling apparatus 50 shown in FIG. 18A includes a concave connection body 212 or yoke configured to receive the tool body 14 therein and support the tool body 14 from below.

In the arrangements illustrated and described with regard to FIGS. 18A-C, the links 200x which are pivotable relative to each other may function essentially as bones, and the elastomeric springs 222 along either side of the links 200x and/or springs 224 between the links 200x may function essentially as ligaments. The biomimicry of the arrangement illustrated in FIGS. 18A-C may enable the motion of the tool body 14 to feel as natural as possible to a user.

Further aspects of the disclosure are provided by one or more of the following embodiments:

A power tool comprising: a frame including a back plate having an upper end and a lower end and defining a back plate plane; and a tool body coupled to the frame by a coupling apparatus, the coupling apparatus including a coupler configured to enable movement of the tool body in a lateral side to side direction relative to the back plate plane; the tool body comprising a user interface configured to be gripped by a user to support and direct movement of the tool body.

The power tool of any one or more of the embodiments, wherein the coupler comprises at least one spring.

The power tool of any one or more of the embodiments, wherein the at least one spring comprises an elongated linear piece of spring steel.

The power tool of any one or more of the embodiments, wherein the elongated linear piece of spring steel extends between a coupler body and the tool body, the coupler body comprising a first clamp block and a second clamp block, wherein a first end of the at least one spring is clamped between the first clamp block and the second clamp block

The power tool of any one or more of the embodiments, wherein the coupler further comprises at least one corrugated body.

The power tool of any one or more of the embodiments, wherein the coupler comprises a coupler body, and the at least one spring extends from the coupler body to the tool body.

The power tool of any one or more of the embodiments, wherein the coupling apparatus further comprises a support bar rigidly coupled to the back plate.

The power tool of any one or more of the embodiments, further comprising a coupling block coupled to the support bar, the coupler being coupled with the coupling block.

The power tool of any one or more of the embodiments, wherein the coupler is translatable relative to the support bar in a direction that is generally perpendicular to the back plate plane.

The power tool of any one or more of the embodiments, the coupling apparatus further comprising a pitch mechanism configured to enable movement of the tool body up and down in a vertical direction.

The power tool of any one or more of the embodiments, wherein the pitch mechanism comprises a bearing and the coupler is configured to rotate about the bearing about a range of motion of about 180 degrees.

The power tool of any one or more of the embodiments, the pitch mechanism further comprising a spring, wherein the spring limits the movement in a downward vertical direction when the tool body is not supported by the user at the user interface.

The power tool of any one or more of the embodiments, wherein the tool body comprises a blower, the blower comprising a blower housing defining a blower inlet bell and a fan-motor chamber, a fan and a motor disposed in the fan-motor chamber, and an outlet tube coupled to a downstream end of the blower housing, wherein the coupler of the coupling apparatus is coupled to the tool body.

The power tool of any one or more of the embodiments, wherein the blower comprises a receiver, wherein the coupler is mounted to the receiver.

The power tool of any one or more of the embodiments, wherein the receiver is mounted within an air intake space of the blower inlet bell.

The power tool of any one or more of the embodiments, wherein the receiver comprises a bearing configured to enable rotation of the blower relative to the coupler.

The power tool of any one or more of the embodiments, wherein the user interface is coupled to the blower inlet bell.

The power tool of any one or more of the embodiments, wherein the user interface is disposed upstream of the fan-motor chamber.

The power tool of any one or more of the embodiments, wherein the user interface is adjustable relative to the blower housing along an axis parallel to a longitudinal axis of the tool body.

The power tool of any one or more of the embodiments, wherein the user interface is movable towards and away from the outlet tube.

This written description uses examples to disclose the present application, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A power tool comprising:
a frame including a back plate having an upper end and a lower end and defining a back plate plane; and
a tool body coupled to the frame by a coupling apparatus,
the coupling apparatus including a coupler configured to enable movement of the tool body in a lateral side to side direction relative to the back plate plane;
the tool body comprising a user interface configured to be gripped by a user to support and direct movement of the tool body.

2. The power tool of claim 1, wherein the coupler comprises at least one spring.

3. The power tool of claim 2, wherein the at least one spring comprises an elongated linear piece of spring steel.

4. The power tool of claim 3, wherein the elongated linear piece of spring steel extends between a coupler body and the tool body, the coupler body comprising a first clamp block and a second clamp block, wherein a first end of the at least one spring is clamped between the first clamp block and the second clamp block.

5. The power tool of claim 2, wherein the coupler further comprises at least one corrugated body.

6. The power tool of claim 2, wherein the coupler comprises a coupler body, and the at least one spring extends from the coupler body to the tool body.

7. The power tool of claim 1, wherein the coupling apparatus further comprises a support bar rigidly coupled to the back plate.

8. The power tool of claim 7, further comprising a coupling block coupled to the support bar, the coupler being coupled with the coupling block.

9. The power tool of claim 7, wherein the coupler is translatable relative to the support bar in a direction that is generally perpendicular to the back plate plane.

10. The power tool of claim 1, the coupling apparatus further comprising a pitch mechanism configured to enable movement of the tool body up and down in a vertical direction.

11. The power tool of claim 10, wherein the pitch mechanism comprises a bearing and the coupler is configured to rotate about the bearing about a range of motion of about 180 degrees.

12. The power tool of claim 10, the pitch mechanism further comprising a spring, wherein the spring limits the movement in a downward vertical direction when the tool body is not supported by the user at the user interface.

13. The power tool of claim 1, wherein the tool body comprises a blower, the blower comprising a blower housing defining a blower inlet bell and a fan-motor chamber, a fan and a motor disposed in the fan-motor chamber, and an outlet tube coupled to a downstream end of the blower housing, wherein the coupler of the coupling apparatus is coupled to the tool body.

14. The power tool of claim 13, wherein the blower comprises a receiver, wherein the coupler is mounted to the receiver.

15. The power tool of claim 14, wherein the receiver is mounted within an air intake space of the blower inlet bell.

16. The power tool of claim 14, wherein the receiver comprises a bearing configured to enable rotation of the blower relative to the coupler.

17. The power tool of claim 13, wherein the user interface is coupled to the blower inlet bell.

18. The power tool of claim 13, wherein the user interface is disposed upstream of the fan-motor chamber.

19. The power tool of claim 13, wherein the user interface is adjustable relative to the blower housing along an axis parallel to a longitudinal axis of the tool body.

20. The power tool of claim 19, wherein the user interface is movable towards and away from the outlet tube.

21. The power tool of claim 1, wherein the coupler comprises a first joint and a second joint.

22. The power tool of claim 1, wherein the coupler comprises a plurality of links, wherein at least two links of the plurality of links are rotatably coupled at a joint.

23. The power tool of claim 22, wherein at least two links of the plurality of links are collapsible relative to each other to enable forward and rearward movement of the tool body with respect to the frame.

24. The power tool of claim 22, wherein the coupler further comprises at least one spring coupled to the at least two links.

25. The power tool of claim 24, wherein the at least one spring is coupled to each link of the plurality of links.

26. The power tool of claim 24, wherein the at least one spring extends between the at least two links.

27. The power tool of claim 1, wherein the coupler supports the tool body from below the tool body.
